(19) United States
(12) Patent Application Publication
(10) Pub. No.: US 2017/0365401 A1
(43) Pub. Date: Dec. 21, 2017

(54) TRANSFORMER HAVING NOISE REDUCTION STRUCTURE

(71) Applicant: HYOSUNG CORPORATION, Seoul (KR)

(72) Inventors: Do Jin KIM, Changwon-si, Gyeongsangnam-do (KR); Chul Jun PARK, Busan (KR); Kyo Ho LEE, Gimhae-si, Gyeongsangnam-do (KR); Boo Yong SEOL, Daegu (KR); Seung Hwan CHOI, Daegu (KR)

(21) Appl. No.: 15/540,944

(22) PCT Filed: Dec. 30, 2015
(86) PCT No.: PCT/KR2015/014494

§ 371 Date: Jun. 29, 2017

(30) Foreign Application Priority Data
Dec. 31, 2014 (KR) 10-2014-0195578

(51) Int. Cl. H01F 27/33; H01F 27/32; H01F 27/24

(52) U.S. Cl. CPC H01F 27/33; H01F 27/24; H01F 27/324

(57) ABSTRACT

The present invention relates to a transformer having a noise reduction structure. A tank (12) forms the exterior of the transformer (10). An inner space (14) filled with insulating oil is formed inside the tank (12). An iron core (20) is provided inside the tank (12) by a lower frame (16) and an upper frame (18), and coils (22) are wound around parts of the iron core (20) extending in the direction of gravity. An insulating sheet (24) is provided to encompass the surface of each of the coils (22), and has ridge portions (26) and groove portions (28), which are formed to extend in the height direction of the iron core (20). It is preferable that the side surfaces of the groove portions (28) are formed in parallel so as to face each other. The present invention as above minimizes the transfer of vibrations, generated from the coils (22), to the insulating sheets (24) provided on the surfaces of the coils (22) and removes a part of the vibrations since the vibrations coming out after having passed through the insulating sheets (24) are transferred to the insulating oil so as to cancel each other out. Therefore, the present invention can relatively reduce vibration and noise, which are generated from the transformer.

### TECHNICAL FIELD

The present invention relates generally to a transformer having a noise reduction structure. More particularly, the present invention relates to a transformer having a noise reduction structure, the transformer being capable of minimizing transmission of vibration and noise through an insulating sheet provided on a surface of a coil.

### BACKGROUND ART

As well known in the art, a transformer is a device that transforms alternating current voltage and alternating current by using electromagnetic induction. The transformer is widely used from a small electronic apparatus to a large-sized power transmission facility or transmission facility. In particular, a high-pressure large capacity transformer is used for the large-sized power transmission facility or transmission facility.

A schematic configuration of such a transformer is shown in FIG. 1. As shown in the drawing, a tank 3 forms an exterior of a transformer 1. An iron core 5 is supported by frames 7 and 7′ in the tank 3, and coils 9 are wound on the iron core 5. The coils 9 are wound in a cylindrical shape, and an insulating sheet 9′ is attached to a surface of each coil 9. The insulating sheet 9′ surrounds the coil 9 to perform insulation.

Further, the tank 3 is filled with an insulating oil that releases heat generated in the coils 9 and the iron core 5 and performs insulation. The insulating oil is transferred to a heat dissipating device (not shown), such that heat is discharged to outside through heat exchange with external air.

However, the conventional transformer having the above-described configuration is problematic in that when a current flows through the coils 9, vibrations are generated due to electromagnetic force. Such vibrations are transmitted to the insulating oil through insulating sheets 9′. Vibrations generated in the coil 9 are transmitted to the insulating sheet 9′ and then directly transmitted to the insulating oil in a direction perpendicular to a surface of the insulating sheet 9′ as indicated by an arrow in FIG. 2. Thus, the vibrations transmitted to the insulating oil continue to be transmitted straight to the tank 3, thereby generating vibration and noise in the tank 3.

### DISCLOSURE

### Technical Problem

Accordingly, the present invention has been made keeping in mind the above problems occurring in the prior art, and an object of the present invention is to provide a transformer having a noise reduction structure, the transformer being capable of minimizing transmission of vibrations generated due to electromagnetic force in a coil to an insulating sheet.

Another object of the present invention is to provide transformer having a noise reduction structure, the transformer being capable of cancelling out vibrations generated due to electromagnetic force in a coil and transmitted through an insulating sheet to an insulating oil.

### Technical Solution

In order to accomplish the above object, the present invention provides a transformer having a noise reduction structure, the transformer including: a tank provided therein with an inner space filled with an insulating oil; an iron core provided in the tank and serving as a passage for lines of magnetic force; coils wound on the iron core, and performing voltage and current transformation through electromagnetic interaction when electric power is applied to the coils; and an insulating sheet surrounding a surface of each of the coils and performing insulation, with ridge portions and groove portions alternately provided on a surface of the insulating sheet.

The insulating sheet may be provided such that ridge portions provided on a surface facing the surface of each of the coils are attached to the surface of the coil.

The opposite side surfaces of each of the groove portions may face each other in parallel.

The ridge portions and the groove portions may be provided on opposite surfaces of the insulating sheet to correspond to each other, such that groove portions of a second surface of the insulating sheet are formed by forming ridge portions of a first surface of the insulating sheet.

The ridge portions and the groove portions may extend in a height direction of each of the coils.

### Advantageous Effects

The transformer having the noise reduction structure according to the present invention has the following effects.

First, the ridge portions and the groove portions are alternately provided on the surface of the insulating sheet, and the ridge portions of the first surface of the insulating sheet are attached to the surface of the coil. Thus, the contact area between the coil and the insulating sheet is minimized and thus the transmission of vibrations generated in the coil to the insulating sheet is minimized, thereby minimizing the transmission of vibrations through the insulating oil to the tank of the transformer.

Second, since the ridge portions and the groove portions are alternately provided on the insulating sheet, vibrations transmitted through surfaces of the ridge portions and the groove portions to the insulating oil destructively interfere with each other. Thus, the transmission of vibrations transmitted through the insulating oil to the tank of the transformer is minimized, thereby reducing vibration and noise of the transformer.

### DESCRIPTION OF DRAWINGS

FIG. 1 is a view showing an internal configuration of a general transformer.

FIG. 2 is a cross-sectional view showing an insulating sheet attached to a surface of a coil of a transformer according to the prior art.

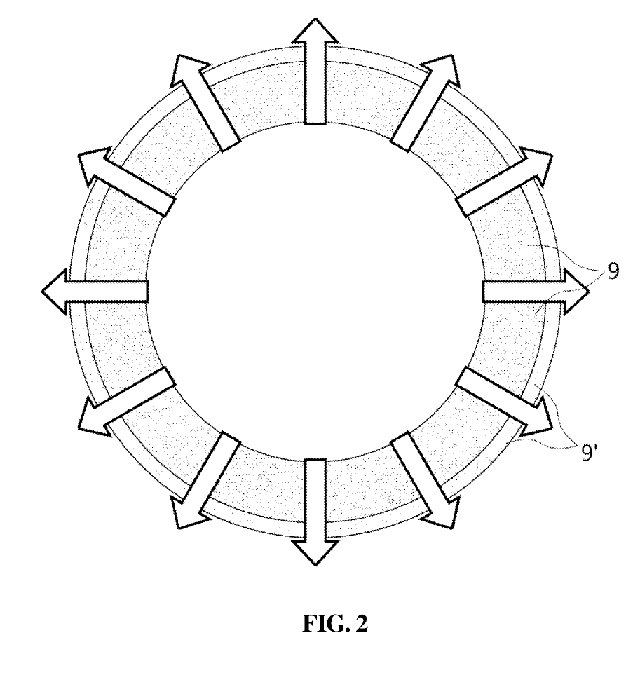

FIG. 3 is a schematic perspective view showing a configuration of a transformer according to a preferred embodiment of the present invention.

FIG. 4 is a cross-sectional view showing a configuration of a main part of the transformer in the embodiment of the present invention.

FIGS. 5a and 5b are views showing that vibrations transmitted to an insulating oil cancel each other out in the embodiment of the present invention.

### MODE FOR INVENTION

Hereinafter, exemplary embodiments of the present invention will be described in further detail with reference to the accompanying drawings. Wherever possible, the same reference numerals will be used throughout the drawings and the description to refer to the same or like elements or parts. In the following description, it is to be noted that, when the functions of conventional elements and the detailed description of elements related with the present invention may make the gist of the present invention unclear, a detailed description of those elements will be omitted.

Further, when describing the components of the present invention, terms such as first, second, A, B, (a), or (b) may be used. Since these terms are provided merely for the purpose of distinguishing the components from each other, they do not limit the nature, sequence, or order of the components. It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present.

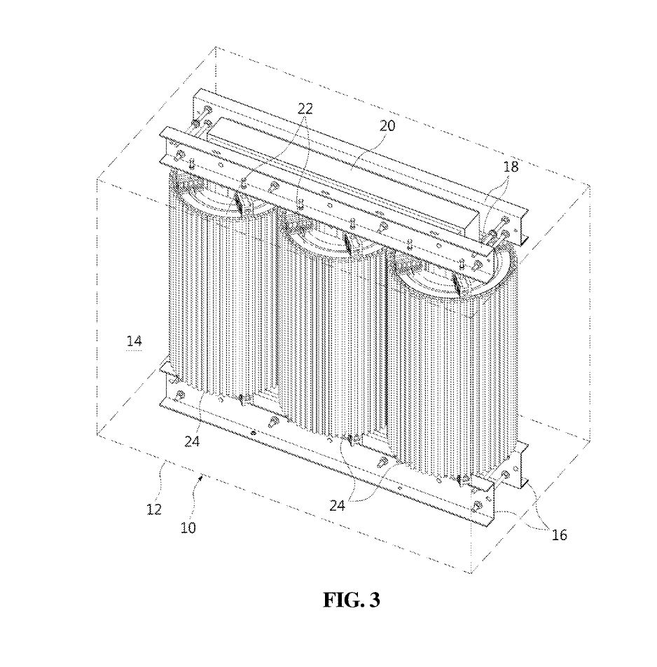

Referring to FIGS. 3 to 5, a transformer 10 according to the present invention is provided with a tank 12 forming an exterior of the transformer. In the drawings of the present specification, only the position and approximate shape of the tank 12 are shown. The tank 12 is provided therein with an inner space 14. The inner space 14 is provided with a transformer body that will be described below. The tank 12 serves to isolate components installed in the transformer 10 from outside.

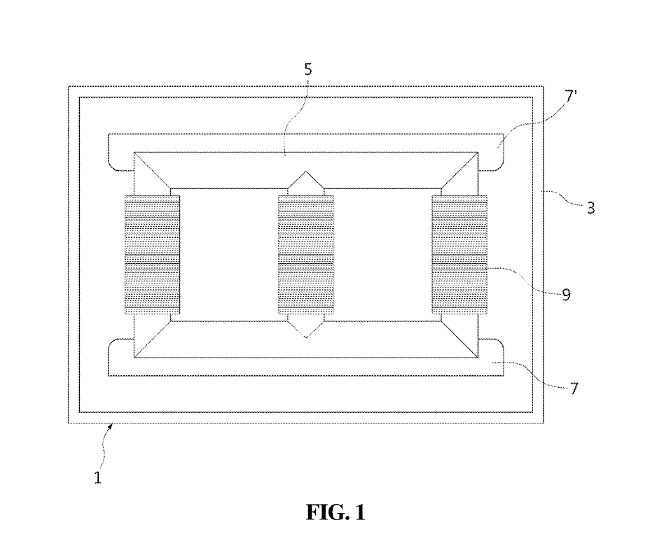

The configuration of the transformer body is described. A lower frame 16 and an upper frame 18 are installed in the inner space of the tank 12, an iron core 20 is installed such that the iron core is erected by the lower and upper frames 16 and 18. The configuration of the iron core 20 remains the same as that shown in FIG. 1. The iron core 20 serves as a passage for lines of magnetic force. In general, the iron core 20 is formed by laminating thin plates containing silicon so as to reduce iron loss.

The iron core 20 is provided with coils 22 wound on vertical portions of the iron core 20. The coils 22 are formed by winding an insulated wire made of copper or a copper alloy having a high conductivity. When electric power is applied to the coils 22, an induced electromotive force or an electromagnetic force can be generated.

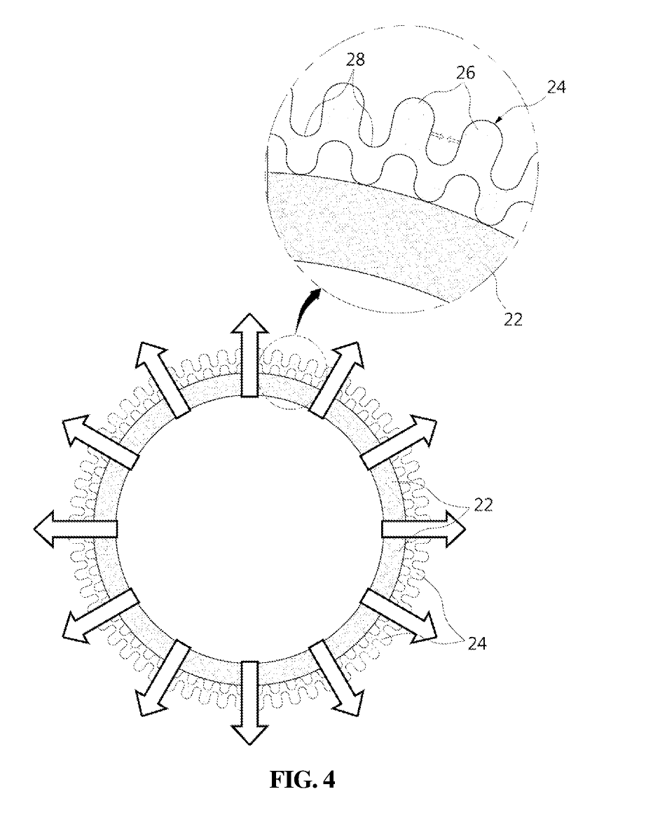

An insulating sheet 24 is attached to a surface of each of the coils 22. The insulating sheet 24 is configured to surround the surface of the cylindrical shaped coil 22 and performs insulation between the coil 22 and a periphery of the coil. As shown in FIG. 4, the insulating sheet 24 is provided with ridge portions 26 and groove portions 28 provided in an alternate manner, such that the insulating sheet has a corrugated structure. The ridge portions 26 and the groove portions 28 extend in a height direction of each of the coils 22. The ridge portions 26 and the groove portions 28 are provided on opposite surfaces of the insulating sheet to correspond to each other. In other words, groove portions 28 of a second surface of the insulating sheet are formed by forming ridge portions 26 of a first surface of the insulating sheet.

The insulating sheet 24 is provided such that ridge portions 26 provided on a surface facing the surface of each of the coils 22, serve as contact portions 30. The contact portions 30 are portions where the insulating sheet 24 is attached to the surface of the coil 22. Thus, the insulating sheet 24 is attached to the surface of the coil 22 only at the contact portions 30.

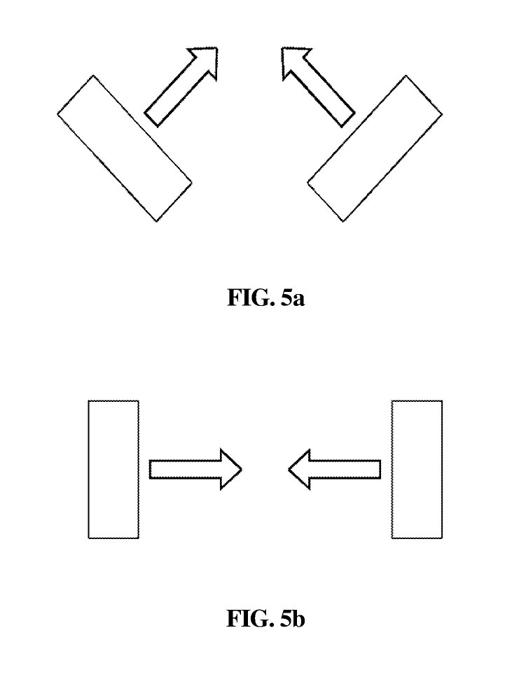

Meanwhile, the groove portions 28 have a substantially ‘U’-shape in cross section. In other words, opposite side surfaces of each of the groove portions 28 face each other in parallel. By forming the opposite side surfaces of each of the groove portions 28 to substantially face each other, when vibrations transmitted to the insulating sheet 24 are transmitted to the insulating oil through the surface of the insulating sheet 24, the vibrations are transmitted in a direction perpendicular to the surface of the insulating sheet 24. Accordingly, as shown in FIG. 5b, the vibrations transmitted to the insulating oil through the side surfaces of each of the groove portions 28 cancel each other out in one groove portion 28. Of course, although vibrations are transmitted to the insulating oil through a peak of each of the ridge portions 26 as well as the side surfaces of each of the groove portions 28, not all of the vibrations transmitted through the ridge portions are transmitted to the insulating oil.

In addition, FIG. 5a shows that the opposite side surfaces of each of the groove portions 28 are provided inclinedly without facing each other. Even in this case, vibrations transmitted through the side surfaces of each of the groove portion 28 to the insulating oil can cancel each other out to some extent. However, not all of the vibrations transmitted to the insulating oil cancel each other out, and a part of the vibrations is transmitted to the tank 12.

Hereinafter, a use of the transformer having the noise reduction structure according to the present invention with the above configuration will be described in detail.

In the transformer 10 of the present invention, when an alternating current is applied to one coil 22, a magnetic field that changes continuously in the coil 22 is generated. When the magnetic field passes through the other coil 22, an alternating current voltage is generated in the other coil 22, wherein a level of the alternating current voltage may be varied depending on a ratio of the number of turns of two coils 22.

During this operation, vibrations are generated by the alternating current applied to the coil 22. Vibrations generated in each of the coils 22 are transmitted to the insulating sheet 24 provided on the surface of the coil 22. The vibrations transmitted to the insulating sheet 24 are transmitted through the insulating sheet 24 to the insulating oil filled in the inner space 14 of the tank 12.

Here, the ridge portions 26 and the groove portions 28 are alternately provided on the insulating sheet 24, and the ridge portions 26 provided on the first surface of the insulating sheet are employed as the contact portions 30 and are attached to the coil 22. As a result, vibrations generated in the coil 22 are transmitted to the insulating sheets 24 only through the contact portions 30. Thus, vibrations transmitted to the insulating sheets 24 can be relatively reduced.

Further, vibrations are transmitted to the insulating oil in the direction perpendicular to the surface of the insulating sheet 24. Since the groove portions 28 of the insulating sheet 24 are formed in a ‘U’-shape, vibrations transmitted through the opposite side surfaces of each of the groove portions 28 to the insulating oil cancel each other out. Such vibrations cancelling each other out in this manner are the same as an arrow B shown in an enlarged view of FIG. 4.

Of course, vibrations transmitted through the peak and a periphery of each of the ridge portions 26 are also transmitted to the insulating oil in the direction perpendicular to the surface of the insulating sheet 24. As indicated by A in the enlarged view of FIG. 4, a part of the vibrations transmitted through each of the ridge portions 26 and vibrations transmitted through an adjacent ridge portion 26 cancel each other out. Of course, not all of vibrations transmitted through ridge portions 26 cancel each other out.

However, as described above, since the insulating sheet 24 is attached to the surface of the coil 24 only at the contact portions 30, vibrations generated in the coil 24 are partially transmitted to the insulating sheet 24. In addition, vibrations transmitted to the insulating oil in opposite directions through the side surfaces of each of the groove portions 28 of the insulating sheet cancel each other out, and vibrations transmitted to the insulating oil through the ridge portions 26 partially cancel each other out. Thus, vibrations generated in the coil 24 and then transmitted to the tank 12 can be relatively reduced, whereby vibration and noise generated in the tank 12 can be relatively reduced.

Meanwhile, the insulating oil receives heat generated in the iron core 20 or the coils 22 and then flows into the heat dissipating device (not shown), thereby performing heat exchange with external air. In this way, the insulating oil having released heat to the external air renters the inner space 14 of the tank 12 to perform insulation and heat dissipation.

Although a preferred embodiment of the present invention has been described for illustrative purposes, those skilled in the art will appreciate that various modifications, additions, and substitutions are possible without departing from the scope and spirit of the invention as disclosed in the accompanying claims. Therefore, the embodiments of the present invention are disclosed only for illustrative purposes and should not be construed as limiting the present invention. The scope of the invention should be determined on the basis of the descriptions in the appended claims, not any specific embodiment, and all equivalents thereof should belong to the scope of the invention.

For reference, although in the illustrated embodiment, the opposite side surfaces of each of the groove portions 28 are parallel to each other, the present invention is not necessarily limited thereto. As shown in FIG. 5a, the opposite side surfaces of each of the groove portions 28 may have a predetermined inclination angle such that virtual lines extending therefrom meet each other. Of course, when the opposite side surfaces of each of the groove portions 28 have the predetermined inclination angle such that the virtual lines meet each other, a certain degree of vibration canceling can be achieved, but the effect of canceling is relatively inferior to the case in which the side surfaces of each of the groove portions 28 are parallel to each other.

1. A transformer having a noise reduction structure, the transformer comprising:
a tank provided therein with an inner space filled with an insulating oil;
an iron core provided in the tank and serving as a passage for lines of magnetic force;
coils wound on the iron core, and performing voltage and current transformation through electromagnetic interaction when electric power is applied to the coils; and
an insulating sheet surrounding a surface of each of the coils and performing insulation, with ridge portions and groove portions alternately provided on a surface of the insulating sheet.

2. The transformer of claim 1, wherein the insulating sheet is provided such that ridge portions provided on a surface facing the surface of each of the coils are attached to the surface of the coil.

3. The transformer of claim 2, wherein opposite side surfaces of each of the groove portions face each other in parallel.

4. The transformer of claim 1, wherein the ridge portions and the groove portions are provided on opposite surfaces of the insulating sheet to correspond to each other, such that groove portions of a second surface of the insulating sheet are formed by forming ridge portions of a first surface of the insulating sheet.

5. The transformer of claim 4, wherein the ridge portions and the groove portions extend in a height direction of each of the coils.

6. The transformer of claim 2, wherein the ridge portions and the groove portions are provided on opposite surfaces of the insulating sheet to correspond to each other, such that groove portions of a second surface of the insulating sheet are formed by forming ridge portions of a first surface of the insulating sheet.

7. The transformer of claim 3, wherein the ridge portions and the groove portions are provided on opposite surfaces of the insulating sheet to correspond to each other, such that groove portions of a second surface of the insulating sheet are formed by forming ridge portions of a first surface of the insulating sheet.
